(19) United States
(12) Patent Application Publication
(10) Pub. No.: US 2012/0211404 A1
(43) Pub. Date: Aug. 23, 2012

(54) METHOD AND DEVICE FOR RECOVERING EXHAUSTED MACHINING SLURRIES

(76) Inventor: Guntram Krettek, Viersen (DE)

(21) Appl. No.: 13/392,566

(22) PCT Filed: Aug. 31, 2010
(86) PCT No.: PCT/DE10/01032

§ 371 Date: May 14, 2012

(30) Foreign Application Priority Data
Sep. 2, 2009 (DE) 10 2009 039 727.2
Sep. 2, 2009 (DE) 10 2009 039 728.0

(51) Int. Cl. B01D 43/00; B03B 7/00; B04B 5/00

(52) U.S. Cl. 209/12.1; 210/787; 210/772; 210/512.3

(57) ABSTRACT

The invention relates to a method for recovering spent machining slurries and to an apparatus for carrying out the method. The spent machining slurry that contains a machining medium, a carrier fluid for the machining medium, material stemming from the machined articles, particles stemming from the machining tools and optionally additives, is recovered by centrifugation in the undiluted state, thereby allowing an especially effective recovery according to materials and without much effort. The used apparatus is characterized in that it comprises a centrifuge having a suspended centrifugal drum or a stationary centrifuge having a floating centrifuging drum.

The present invention is directed to a method for recovering spent machining slurries that contain a machining medium, a carrier fluid for the machining medium, material stemming from the machined product, particles stemming from the machining tool and optionally additives.

In many machining operations a machining fluid is used that contains a machining medium, for instance an abrasive medium, and a carrier fluid for the machining medium. Furthermore, the fluid can contain certain additives. After the realized machining (mechanical machining), for instance a sawing, grinding, lapping, a so-called machining slurry results that contains the machining medium, the carrier fluid for the machining medium, material stemming from the machined product, particles stemming from the machining tool and optionally additives. This slurry is a material with a muddy or pasty consistency that is to be recovered since it contains a number of valuable substances.

The sawing of silicon ingots is an example of a machining process according to which such machining slurries are obtained. Silicon suitable for chips and solar installations is produced in the so-called one-crystal melting process from rods with a length up to 2 m and a diameter up to 300 mm, the so-called ingots. These ingots are sawn into very thin slices (wafers) with a thickness up to 130-650 μm by means of so-called wire saws, i.e. an iron wire is led through the silicon block as saw. To bring this wire in a state to be able to cut at all it is continuously coated with a so-called sawing suspension. The suspension consists of a carrier fluid as viscosity giving substance, for instance polyethylene glycol PEG, and a machining medium that is an abrasive medium, for instance silicon carbide SiC, in a graining suitable for the respective cutting process or sawing process. In most of the cases this suspension is prepared in a mixing ratio of 50:50. In the sawing process pure silicon (machining material) is obtained as “waste”, per cut about 300 μm of the ingot, which becomes enriched in the sawing suspension. The suspension can be used for sawing several times but after few passes the suspension is spent on account of the silicon concentrations becoming higher and higher.

As recovering method a system exists that works with hydrocyclones and many aqueous dilution stages and at the end results in a separation of polyethylene glycol and solid, in this case SiC and SiO₂. A continued separation of SiC and SiO₂ is not possible with this method. Furthermore, the method works only up to a particle size of max. 5 μm. Since it is operated in aqueous dilution the water portion in the polyethylene glycol has to be removed in an extensive and expensive manner. A recovering of the chip or solar silicon is not possible with this method since the elemental silicon is oxidatively reacted to SiO₂ and the hydrate forms thereof by the aqueous dilution.

From DE 10 2007 048 879 A1 a method of recovering fluid sawing slurries as well as their use for the production of wafers with improved surfaces are known. This is specially directed to the recovering of spent fluid separation media containing a fluid, sawing particles, detached grinding particles from sawing product material as well as optionally auxiliary substances wherein the fluid is separated from the sawing particles. This is made by means of a filtration through a core spur filter. The fluid permeate obtained in such manner is further used wherein it still contains finest grinding particles from sawing product material. Accordingly, this known method uses a filtration method for the recovering.

In U.S. Pat. No. 6,231,628 B1 a method of handling a spent machining slurry resulting from the sawing of silicon wafers from a silicon ingot is described. According to this method the spent slurry is heated in order to reduce the viscosity and thereafter separated into a liquid fraction and a solid fraction. The separation process is carried out by means of filtration. The further processing of the solid fraction is carried out through dilution is with water and the use of hydrocyclones.

It is the object of the present invention to provide a method of the above-cited kind with which an especially effective and species-pure recovering with small effort, especially without disadvantageous and time-consuming dilution steps, can be obtained.

According to the invention this object is attained with a method of the cited kind according to a first embodiment of the invention by the centrifuging of the undiluted spent machining slurry and thereby by the separation of the machining medium from the remaining part of the slurry.

The inventive method according to this embodiment uses a completely different onset as with the prior art. Here, the machining slurry is not diluted with water so that the valuable substances in the slurry are not contaminated. Rather a species-pure separation of the valuable substances in the field of force of the centrifuge takes place. With this embodiment no fluid-solid-separation takes place but the machining medium, for instance silicon carbide, is directly separated from the remaining part of the slurry as solid by centrifuging wherein the remaining part of the slurry still contains the carrier fluid for the machining medium, for instance polyethylene glycol, material stemming from the machined product, for instance silicon, particles stemming from the machining tool, for instance iron particles of the saw, and optionally additives. Here, one uses the fact that the solids contained in the slurry, namely the machining medium (SiC) on the one side and the material stemming from the machined product (Si) with particles (Fe) stemming from the machining tool on the other side, are present in a grain size distribution existing in a bimodal form so that a separation with a sharp cut by centrifuging can result. Here, the above-described separation can be obtained in the field of force of the centrifuge without the addition of further auxiliary liquids. So, for instance, SiC used as machining medium has an average particle size of more than 1.0 μm while Si as material stemming from the machined product has an average particle size of below 1.0 μm so that machining medium present as solid can be separated by centrifuging without any problems. Dependent on the material the corresponding parameters, as centrifuging factor, flow rate, temperature, viscosity, duration, are to be determined empirically. Preferred centrifuging factors are in a range of 250-3,000 g.

Accordingly, with the inventive classifying or centrifuging technique according to this embodiment no customary separation into the liquid and the solid components by centrifuging takes place. Instead, a solid component, namely the machining medium, is separated from the remaining liquid slurry that still contains the other solid components, namely material stemming from the machined product, particles stemming from the machining tool and optionally additives. The machining medium, which preferably has a grain size distribution with a larger average grain size than the remaining solid components, is obtained during the centrifuging as solid phase (cake) and can be led to further machining stages. According to the invention a classifying process takes place according to which the bimodal distribution between fine material and coarse material present in the slurry system is separated or cut. The corresponding materials are separated from one another with the use of optimized centrifuging parameters.

The separated machining medium, especially SiC that has settled as solid cake on the inner wall of a centrifuge drum is removed from the centrifuge by means of mechanical means or by means of a redispersing fluid and is especially led to further processing. Preferably, the separated machining medium is redispersed by means of a redispersing fluid according to the inventive method and is then again separated from the redispersing medium for further use. The further processing of the machining medium can be carried out through a plurality of further method steps dependent on the respective profile of request. So, for instance, after the redispersion of the machining medium the corresponding portion of the particles stemming from the machining tool that is still contained in the machining medium can be separated by means of a magnet separator. Preferably, through the redispersing a washing process is carried out in addition to the draining from the centrifuge wherein, for instance, hexane is used as redispersing fluid. The machining medium that has been washed and that has been cleaned from particles (Fe) stemming from the machining tool can then be dehumidified, for instance, in order to clean the same from the redispersing fluid and from remaining carrier fluid. One or more further separation methods can be carried out in order to separate remaining material (Si) stemming from the machined product.

On the whole, for the further processing of the machining medium any separation methods, as centrifuging, filtration, settling methods etc., can be used.

One succeeds in this manner to recover the machining medium from the spent machining slurry so that the machining medium can be led to a suitable further use, for instance for the production of new sawing suspension.

According to another preferred embodiment of the inventive method the remaining valuable substances of the spent machining slurry are completely or partly recovered, too. Preferably, this is realized by separating the remaining part of the spent machining slurry by centrifuging into materials stemming from the machined product with particles stemming from the machining tool and into carrier fluid. Accordingly, in this centrifuging step a true separation step between solid phase and liquid phase is carried out wherein as solid phase the material stemming from the machined product with particles stemming from the machining tool (Si with Fe) is separated from the carrier fluid (PEG).

The obtained material stemming from the machined product with particles stemming from the machining tool is especially separated by a solid separation method, preferably a magnetic separation method, so that more or less pure material stemming from the machined product results that, for instance, can be led through several washing and filtration processes and can be recovered as pure valuable substance. The same can be again used as material stemming from the machined product (silicon one-crystal production), for instance. In this manner a closed circuit of valuable substances is attained.

The separated carrier fluid can be subjected to one or more further processing steps in order to clean the same. For instance, it can be used again as carrier fluid for the machining medium (as sawing suspension etc.).

Preferably, the inventive recovering method is used for the recovering of spent machining slurries that are obtained during the sawing of silicon ingots. These machining slurries contain as machining medium an abrasive medium, especially silicon carbide, a carrier fluid for the machining medium, especially polyethylene glycol, material stemming from the machined product removed by sawing, namely silicon, and iron particles from the saw as particles stemming from the machining tool as well as optionally any additives.

According to a second embodiment of the invention the above-cited object is attained with a method of the cited kind by subjecting the undiluted spent machining slurry to a solid-liquid-separation into carrier fluid and remaining solids by centrifuging.

The inventive method of this embodiment also uses another onset as with the prior art. Here, the machining slurry is not diluted with water, too, which would result in a contamination of the valuable substances. The valuable substances are rather separated from one another by centrifuging wherein especially extremely high-speed centrifuges are used with which a species-pure separation of the valuable substances in the field of force of the centrifuge is obtained. According to the invention an effective solid-liquid-separation is carried out by means of such centrifuges, i.e. the carrier fluid is separated from the remaining solids (machining medium, material stemming from the machined product, particles stemming from the machining tool and optionally additives).

The separated carrier fluid can be led to different purposes of use. Especially, it can be used again for the production of machining slurries. Preferably, a cleaning of the separated carrier fluid takes place, especially a washing process with a solvent, as for instance hexane.

Preferably, the remaining solids obtained during centrifuging as solid cake are separated from one another by further separation methods in order to reach a complete recovering of the slurry. Here, different separation methods can be used. For instance, the particles stemming from the machining tool are separated by a magnetic separation method if the particles stemming from the machining tool consist of a magnetic material, as iron. For instance, during the recovering of the remaining solids further centrifuging methods, filtration methods etc. can be used.

For instance, after separation of the particles stemming from the machining tool, the machining medium and the material stemming from the machined product can be separated from one another by another centrifuging method wherein in this case the fact is used that the grain size distributions of both materials are present in a bimodal form. The same can be divided with a sharp cut by centrifuging (classifying). Herewith, an extensive separation of machining medium and material stemming from the machined product can be reached without the addition of further auxiliary liquids (no contamination).

The resulting streams of valuable substances can be led to special uses. However, they can be also united in a slurry management system to obtain machining suspensions and thus can be reconducted again to the beginning of the machining process, i.e. the creation of valuable substances. The separated machining material can be recovered as pure substance through washing and/or filtration processes. The aim is a closed circuit of valuable substances.

The term “machining slurry” that is used here is to cover sludges, slips, pastes etc., i.e. materials with all viscosity ranges between liquid and solid.

As already mentioned, according to this embodiment of the inventive method preferably high-speed centrifuges are used. So, it is especially operated with a centrifuging factor >3,000 g, especially in a range of 10,000-20,000 g, during centrifuging. In this field of operation the carrier fluid can be exactly separated from the remaining solids of the spent machining slurry (with a high degree of purity).

As regards the temperature range during centrifuging, it is preferably centrifuged in a temperature range <80° C., especially in a range of 50-80° C. This temperature range is optimum in order to not to have to operate with too high centrifuging factors. On the other side, the inventive method of this embodiment does not conclusively request a step for the viscosity reduction.

The above-cited high centrifuging factors can be realized only with special centrifuges that are able to control the corresponding bearing forces. So, it is preferably operated with centrifuges with large classifying surface and small inner diameter, especially with centrifuges with a relatively high slenderness ratio. Especially, centrifuges having a slenderness ratio L/D>1.2 are used wherein L is the length or height of the classifying surface in the centrifuge drum and D is the inner diameter of the centrifuge drum.

For instance, such a centrifuge is described in DE 199 25 082 B4. Preferably, one operates with such a centrifuge.

As regards the recovering of the solid cake formed in the centrifuge, the same can be removed mechanically, for instance through peeling steps with suitable scraping devices/knife devices. However, the remaining solids (solid cake) separated during the centrifuging can be also redispersed by means of a redispersing fluid and then again separated from the redispersing fluid for further use. Combinations of both methods can be also used. When redispersing the solid cake can be solved by a high pressure jet and can be separated, for instance.

As mentioned above, high centrifuging factors can be realized by the use of the described centrifuges with high slenderness ratio without generating bearing forces that are no more controllable. Furthermore, a minimization of splashing grains and a catching of fine particles is reached since the distance between charge and discharge is especially high with these centrifuges.

Preferably, this embodiment of the inventive method is also used for the recovering of spent sawing slurries during the is sawing of ingots, especially silicon ingots. In such sawing slurries especially a glycol, particularly polyethylene glycol, is used as carrier fluid. Here, especially silicon carbide is used as machining medium that serves as abrasive material.

This does not exclude that the inventive method can be also used for the recovering of machining slurries resulting from other machining processes, as grinding, lapping etc.

Furthermore, the present invention is directed to an apparatus for carrying out the first embodiment of the inventive method. Such an apparatus, for carrying out the basic centrifuging step, i.e. the separation of the machining medium from the remaining part of the slurry, includes a centrifuge that is suitable for especially high speeds or centrifuging factors. With this centrifuge optimized centrifuging factors, preferably in a range of 250-3,000 g, have to be adjusted dependent on the respective kind of material, viscosity, temperature, throughput capacity, duration etc. A centrifuge with suspended centrifuging drum is especially suited for the inventive method of this embodiment. A standing centrifuge with centrifuging drum supported in a flying manner has also a good attitude wherein a centrifuge with flying centrifuging drum is especially preferred that has a high slenderness ratio with L/D>1.2 wherein L is the length or height of the centrifuging drum and D is the inner diameter of the centrifuging drum.

Preferably, such centrifuges are also used for the further method steps, especially for the separation of the remaining part of the spent machining slurry into material stemming from the machined product with particles stemming from the machining tool and into carrier fluid.

Furthermore, the present invention is directed to an apparatus for carrying out the second embodiment of the inventive method. Such an apparatus includes a centrifuge that is preferably a centrifuge with a suspended centrifuging drum. In another embodiment a standing centrifuge with a centrifuging drum supported in a flying manner is used. As mentioned above, these centrifuges have preferably a large classifying surface and a small diameter and have a high slenderness ratio with L/D>1.2. For this, especially a centrifuge described in DE 199 25 082 B4 is used.

In the following the invention is described by means of examples in connection with the drawing in detail. Of the drawing

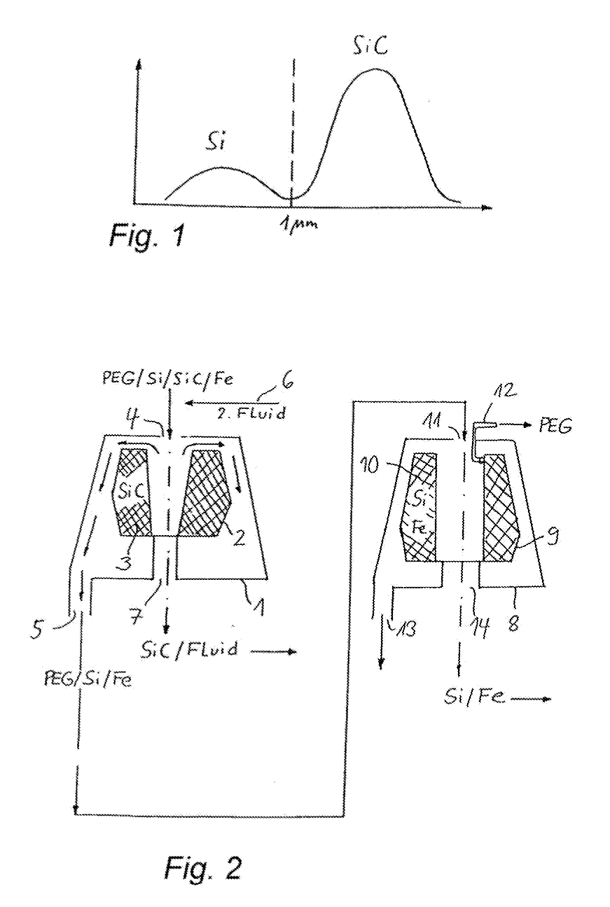

FIG. 1 shows a diagram according to which the particle size is indicated on the abscissa and the distribution density is indicated on the ordinate, of a bimodal distribution of the substances Si and SiC;

FIG. 2 shows a flow chart of a first embodiment of a method for recovering a spent machining slurry of a sawing suspension used for the sawing of silicon ingots;

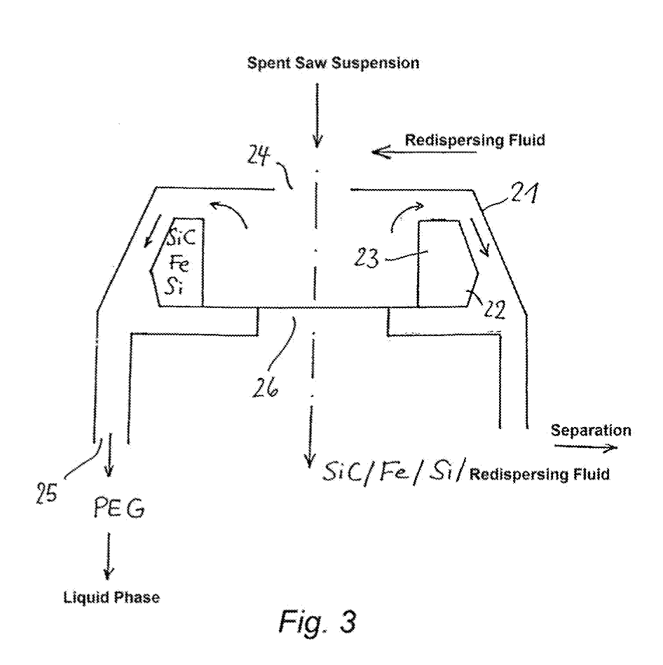

FIG. 3 shows a schematic representation of a centrifuging step for the separation of the carrier fluid of the solids of a sawing suspension according to a second embodiment of the inventive method;

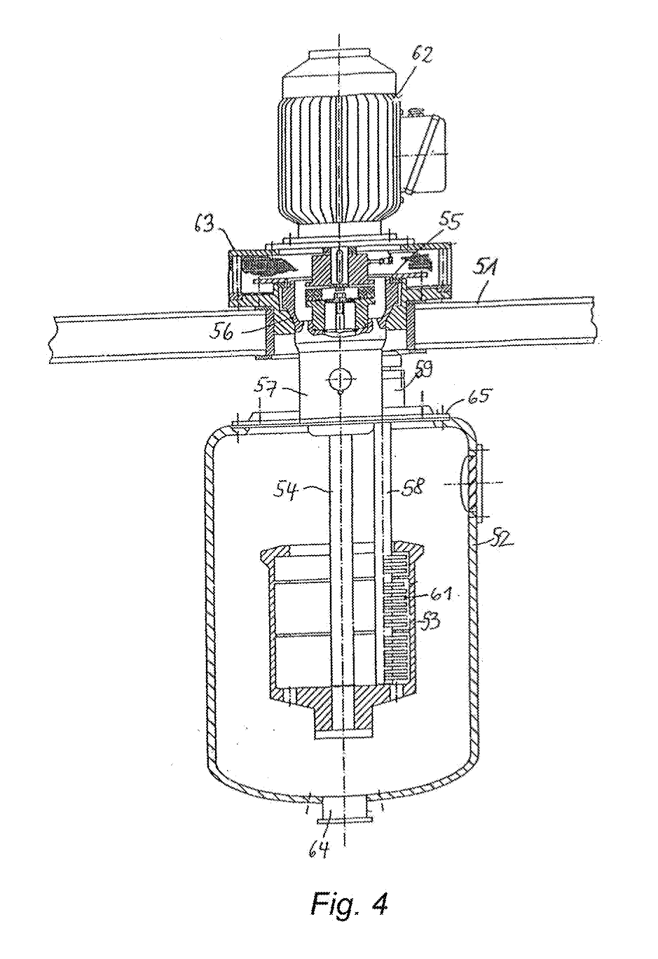

FIG. 4 shows a part vertical section through a centrifuge with a suspended centrifuging drum that is used for the second embodiment of the inventive method; and

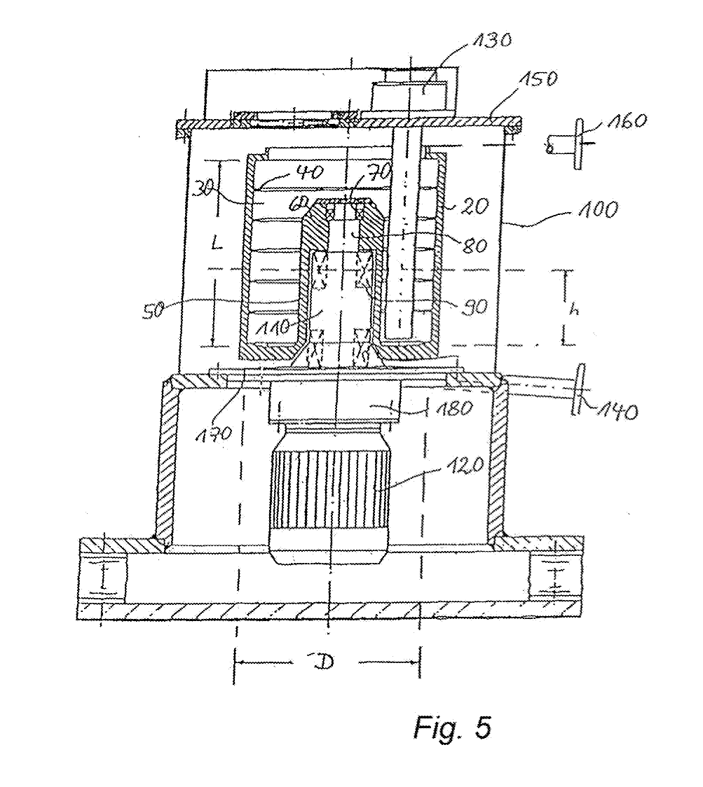

FIG. 5 shows a part vertical section through a standing centrifuge that is used for the second embodiment of the inventive method.

In the diagram of FIG. 1 the distribution density is shown in dependence on the particle size of the substances Si and SiC in a spent machining slurry that results with the sawing of silicon ingots. The distribution corresponds to a bimodal distribution according to which the substances Si and SiC have different maxima of the distribution densities, namely for Si below 1.0 μm and for SiC above 1.0 μm. According to the first embodiment of the inventive method for recovering such a spent slurry a separation of the grain size distribution present in a bimodal form is carried out through centrifuging (classifying) with a sharp cut approximately at a particle size of 1 μm.

FIG. 2 shows the schematic flow of this embodiment of the recovering method. The spent machining slurry that has to be recovered consists of polyethylene glycol (PEG) (carrier fluid for the machining medium), silicon (Si) (material stemming from the machined product), silicon carbide (SiC) (machining medium) and iron particles (Fe) (particles stemming from the machining tool). The machining slurry is introduced into a schematically shown centrifuge 1 at 4 and enters into the centrifuging drum 2. A separation of the silicon carbide from the remaining part of the machining slurry on account of the larger density and particle size of the silicon carbide in relation to the remaining solids is realized by rotation of the drum with a suitable speed (a suitable centrifuging factor). As shown at 3, the silicon carbide is settled as cake on the inner wall of the drum 2 while the remaining slurry, which substantially consists of the components PEG/Si/Fe, is drawn off and is discharged from the centrifuge at 5.

The SiC cake 3 is removed from the drum 2 by redispersing in that a second fluid is introduced into the centrifuging drum at 6 and solves the cake. The solved cake (SiC/fluid) leaves the centrifuge at 7 and is conducted to further use, for instance cleaning, dehumidification etc., in order to be recovered as valuable substance.

The remaining slurry (PEG/Si/Fe) discharged from the centrifuge 1 is led to a second centrifuge 8 and is introduced into the same at 11. The solid mixture Si/Fe is separated from the fluid by the rotation of the centrifuging drum 3 with a certain speed (with a certain centrifuging factor) and gets stuck at the inner wall of the drum 9. The fluid (PEG) is removed from the drum at 12. The mixture of solids Si/Fe 10 is removed from the drum 9 (either mechanically or by means of a redispersing fluid) and is discharged from the centrifuge at 14. Then, further processing stages, especially a magnetic separation stage for the separation of Fe, follow that are not shown here. The cleaned Si can be further used as valuable substance.

The selection of the suitable speed or of the suitable centrifuging factor for the centrifuge 1 used for the bimodal classification depends on several parameters, for instance the kind of material, the temperature, the viscosity, the throughput. In the above-described case for the separation of SiC centrifuging factors of about 250-3,000 g are used.

FIG. 3 shows schematically a centrifuge 21 with an outer casing and an inner centrifuging drum 22 for carrying out the second embodiment of the inventive method. A separation into a liquid phase and into a solid phase is realized by the rotation of the centrifuging drum 22 wherein the solid phase settles on the radial inner wall of the drum 22 in the form of a solid cake 23. In the present case spent sawing suspension consisting of a machining medium, here silicon carbide, a carrier fluid for the machining medium, here polyethylene glycol (PEG), material stemming from the machined product, here silicon, and particles stemming from the machining tool, here iron, is introduced into the centrifuging drum 22 through an inlet 24. A separation into the solids SiC, Fe and Si that settle as solid cake 23 and the carrier fluid PEG that is discharged from the drum as liquid phase through an overflow and an outlet 25 is realized by the rotation of the centrifuging drum 22. The solid cake 23 is discharged from the inner wall of the drum 22 in a redispersing phase in which the drum 22 rotates with low speed. For this, a redispersing fluid is applied as jet with high pressure onto the solid cake 23, for instance, so that the same is released from the inner wall of the drum and is discharged through the outlet 26. The dispersion formed hereby consisting of SiC/Fe/Si and the redispersing fluid is recovered again by separating the redispersing fluid. Thereafter, the iron particles can be separated, for instance, by means of a magnetic separation process. For instance, the remaining SiC/Si mixture can be separated with a sharp cut through a classifying process in another centrifuge since these substances have grain size distributions present in a bimodal form.

FIGS. 4 and 5 show two examples of centrifuges that can be used for the above-described separation method of the second embodiment.

FIG. 4 shows an embodiment of a centrifuge with suspended centrifuging drum in a part vertical section. The centrifuge has an outer casing 51 surrounding a relatively large space in which an inner casing 52 surrounding a centrifuging drum 53 is disposed. The inner casing 52 is provided with a lid 65 that is fixed at the bearing casing 55, namely at a bearing sleeve 57 of the bearing casing. The shaft bearing 55 is mounted in an opening of the outer casing 51 in a sealed manner and has a portion 56 with the shape of a spherical calotte with which the bearing is supported pivotally or flexibly in a corresponding spherically formed bearing pan of a part of the shaft bearing 55 that is fixedly mounted at the outer casing 51. Accordingly, the bearing sleeve 57 can carry out pivotal movements relative to the outer casing 51 wherein the inner casing 52 moves with the same.

A suitable shaft drive 62 in the form of an electric motor is arranged outside of the outer casing 51. A cover 63 serves for covering the shaft bearing 55. In the interior of the bearing sleeve 57 one or more roller bearings (not shown) are disposed that rotatably support the shaft 54 within the bearing sleeve 57. Accordingly, the shaft 54 can carry out a rotating movement and a pivoting movement or oscillating movement.

Means 59 for the removal of the solid cake are fixed at the lid 65 of the inner casing 52 or at the bearing sleeve 57. The means 59 include an arm 58 extending through the lid of the inner casing 52 and carrying a corresponding knife 61 for the removal of the solid cake. An outlet 64 is arranged at the lower end of the inner casing.

In this embodiment it is assured by the mounting of the inner casing 52 at the shaft bearing 55 and of the removal means 59 at the lid 65 of the inner casing 52 or at the bearing sleeve 57 that the inner casing and the removal means 59 also carry out the pivoting or oscillating movements of the shaft 54 so that always parallelism occurs between the arm 58 and the shaft 54 or the drum wall.

The “standing” centrifuge shown in FIG. 5 operates as wet classifying means and has a stationary casing 100 with a lid 150 arranged thereupon. The stationary casing 100 is supported on a supporting frame by means of suitable vibration damping means. A centrifuging drum 20 with vertical axis is disposed within the stationary casing 100 and is rotated by a vertical shaft 80. The vertical shaft 80 extends into the centrifuging drum 20 from below. It is surrounded by a support casing 110 containing an upper main bearing 90 and a lower second bearing for supporting the shaft 80. The support casing 110 is fixed at a plate 170 that on the other hand is fixed at the stationary casing 100. The shaft 80 extends through the support casing 110 and the plate 170 downwardly through suitable coupling means 180 to an electric motor 120 forming a direct drive. The speed of the shaft 80 is controllable.

The centrifuging drum 20 has a suitable admission 130 for the sawing suspension that is to be classified. The admission extends in the shape of a tube through the upwardly open centrifuging drum into the same up to its lower end portion and has an outlet opening at this place. The classified sawing suspension (polyethylene glycol) is drawn off from the upper end of the centrifuging drum 20 by means of a discharge tube 160. A discharge tube 140 at the lower end of the centrifuging drum serves for discharging the sediment (SiC, Si, Fe).

Accordingly, as one can take from the figure, the centrifuging drum is formed like a circular ring in its lower portion and circularly in its upper portion. Horizontal baffles 40 divide the interior of the centrifuging chamber into six classifying chambers 30 one upon the other wherein the sediment is settled in their radial end portions. The sediment is removed therefrom by means of suitable removal means (not shown).

As mentioned above, it is the object to form the centrifuging drum 20 as slim as possible and to arrange the main bearing 90 of the shaft as centrally as possible, i.e. in the range of the gravity center of the centrifuging drum. This has been realized with the present embodiment. One recognizes that in this case the main bearing 90 is arranged so deep in the centrifuging drum that the vertical center of the main bearing 90 of the shaft 80 is arranged at a height h, measured from the inner lower end of the centrifuging drum, which corresponds to about 40% of the length or height L of the classifying surface in the centrifuging drum 2. Furthermore, the slenderness ratio L/D of the centrifuging drum, i.e. the ratio between the length or height of the classifying surface within the centrifuging drum and the inner diameter of the centrifuging drum, has a value of about 1.24. Of course, the above-cited values are only examples. In this embodiment six classifying chambers 30 disposed one above the other result in the centrifuging drum 20.

As mentioned above, an upper main bearing 90 and a lower second bearing for the shaft 80 are disposed within the support casing 110. By this, a stable support results. The shaft 80 extends on the top outwardly from the support casing 110 and terminates in a portion with reduced diameter. The central hub 60 of the centrifuging drum is fixed at this portion and is formed in axial prolongation of the cylindrical inner wall 50 of the centrifuging drum. The fixation is realized through frictional contact (at 70). At the upper end the hub 60 is closed by means of a lid.

The centrifuge is characterized by the feature that a large distance between the charging point and the discharging point and thus a reduction of the danger of short circuit flows results by the high slenderness ratio that results in an improved separation. Furthermore, a high centrifuging factor (it can be operated with high speeds) and a large classifying surface are achieved by a plurality of superposed chambers.

1-29. (canceled)

30. A method for recovering exhausted machining slurries containing a machining medium, a carrier fluid for the machining medium, material stemming from the machined product, particles stemming from the machining tool and optionally additives, characterized by centrifuging the undiluted exhausted machining slurry and thereby separating the machining medium from the remaining part of the slurry.

31. The method defined in claim 30 wherein the separated machining medium is redispersed by means of a redispersing fluid and then separated again from the redispersing medium for further use.

32. The method defined in claim 30 wherein the remaining part of the exhausted machining slurry is separated by centrifuging into material stemming from the machined product with particles stemming from the machining tool and into carrier fluid.

33. The method defined in claim 32, wherein the obtained material stemming from the machined product with particles stemming from the machining tool is separated by a solid separation method, especially a magnetic separation method.

34. The method defined in claim 32, wherein the separated carrier fluid is cleaned.

35. The method defined in claim 33, wherein the separated material stemming from the machined product is recovered as pure substance by washing and/or filtration processes.

36. The method defined in claim 30 wherein it is used for recovering exhausted sawing slurries resulting from the sawing of silicon ingots, the exhausted sawing slurries containing a glycol, especially polyethylene glycol, as carrier fluid and silicon carbide as machining medium.

37. A method for recovering exhausted machining slurries containing a machining medium, a carrier fluid for the machining medium, material stemming from the machined product, particles stemming from the machining tool and optionally additives, characterized in that the undiluted exhausted machining slurry is subjected to a solid-liquid separation into carrier fluid and remaining solids by centrifuging.

38. The method defined in claim 37, wherein the remaining solids are separated by further separation methods.

39. The method defined in claim 38, wherein the particles stemming from the machining tool are separated by a magnetic separation method.

40. The method defined in claim 37, wherein the separated carrier fluid is cleaned.

41. The method defined in claim 37, wherein the separated material stemming from the machined product is recovered as pure substance by washing and/or filtration processes.

42. The method defined in claim 37, wherein it is operated with a centrifuging factor >3,000 g, especially in a range of 10,000-20,000 g, during centrifuging.

43. The method defined in claim 37, wherein it is centrifuged in a temperature range <80° C., especially in a range of 50-80° C.

44. The method defined in claim 37, wherein the remaining solids separated through centrifuging are redispersed by means of a redispersing fluid and are then again separated from the redispersing fluid for further use.

45. The method defined in claim 37, wherein it is used for recovering exhausted sawing slurries resulting from the sawing of ingots, especially silicon ingots, the exhausted sawing slurries containing a glycol, especially polyethylene glycol, as carrier fluid and silicon carbide as machining medium.

46. An apparatus for carrying out the method defined in claim 30 wherein it includes a centrifuge with suspended centrifuging drum.

47. An apparatus for carrying out the method defined in claim 30 wherein it includes a standing centrifuge with centrifuging drum supported in a flying manner.

48. The apparatus defined in claim 47, wherein the centrifuge with centrifuging drum supported in a flying manner has a slenderness ratio with L/D>1.2, wherein L is the length or height of the centrifuging drum and D is the inner diameter of the centrifuging drum.

49. An apparatus for carrying out the method defined in claim 37, wherein it includes a centrifuge with suspended centrifuging drum.

50. An apparatus for carrying out the method defined in claim 37, wherein it includes a standing centrifuge with centrifuging drum supported in a flying manner.

51. The apparatus defined in claim 50, wherein the centrifuge has a large classifying surface and a small diameter, especially a high slenderness ratio with L/D>1.2, where L is the length or height of the centrifuging drum and D is the inner diameter of the centrifuging drum.
